(19) United States
(12) Patent Application Publication
(10) Pub. No.: US 2004/0107189 A1
(43) Pub. Date: Jun. 3, 2004

(54) System for identifying similarities in record fields

(75) Inventors: Douglas R. Burdick, Ithaca, NY (US); Steven Rostedt, Endwell, NY (US); Robert J. Szczerba, Endicott, NY (US)

Correspondence Address: TAROLLI, SUNDHEIM, COVELL & TUMMINO L.L.P., 526 SUPERIOR AVENUE, SUITE 1111, CLEVEVLAND, OH, 44114, US

(73) Assignee: Lockheed Martin Corporation

(21) Appl. No.: 10/308,763

(22) Filed: Dec. 3, 2002

(51) Int. Cl. G06F 7/00

(52) U.S. Cl. 707/3

(57) ABSTRACT

A system identifies similarities in data. The system includes a collection of records, a plurality of transform functions, and a cell list structure. Each record in the collection represents an entity and has a list of fields. Data is contained in each field. The plurality of transform functions operates upon the data in each field in each record. The plurality of transform functions generates a set of output values for facilitating comparison of the records and determining whether any of the records represent the same entity. The cell list structure is generated from the output values. The cell list structure has a list of cells for each field and a list of pointers to each cell of the list of cells for each output value generated by the plurality of transform functions.

### FIELD OF THE INVENTION

The present invention relates to a system for cleansing data, and more particularly, to a system for identifying similarities in record fields obtained from electronic data.

### BACKGROUND OF THE INVENTION

In today's information age, data is the lifeblood of any company, large or small; federal, commercial, or industrial. Data is gathered from a variety of different sources in various formats, or conventions. Examples of data sources may be: customer mailing lists, call-center records, sales databases, etc. Each record from these data sources contains different pieces of information (in different formats) about the same entities (customers in the example case). Each record from these sources is either stored separately or integrated together to form a single repository (i.e., a data warehouse or a data mart). Storing this data and/or integrating it into a single source, such as a data warehouse, increases opportunities to use the burgeoning number of data-dependent tools and applications in such areas as data mining, decision support systems, enterprise resource planning (ERP), customer relationship management (CRM), etc.

The old adage “garbage in, garbage out” is directly applicable to this environment. The quality of the analysis performed by these tools suffers dramatically if the data analyzed contains redundant values, incorrect values, or inconsistent values. This “dirty” data may be the result of a number of different factors including, but certainly not limited to the following: spelling errors (phonetic and typographical), missing data, formatting problems (incorrect field), inconsistent field values (both sensible and non-sensible), out of range values, synonyms, and/or abbreviations. Because of these errors, multiple database records may inadvertently be created in a single data source relating to the same entity or records may be created which don't seem to relate to any entity. These problems are aggravated when the data from multiple database systems is merged, as in building data warehouses and/or data marts. Properly combining records from different formats becomes an additional issue here. Before the data can be intelligently and efficiently used, the dirty data needs to be put into “good form” by cleansing it and removing these mistakes.

Thus, data cleansing necessarily involves the identifying of similarities between fields in different records. The simplest approach for determining which records have “similar” values for a particular field would be to define only identical values to be “similar”. If two records have the same value for the field, they would be considered to have similar values. Otherwise, they would not. This approach is very prone to “noise,” or errors present in the data causing differences between records describing the same object (i.e., causes records to have different values for the field).

Certain portions of a field value are less prone to “noise” than others and these portions of the record field may be unique to a single value (i.e., only records likely intended to have the same value for the entire record value have the same value for this type of portion). This observation has been typically exploited as follows: Two records with identical values for these portions of the field could reasonably be assumed to have been intended to have the same value for the field (despite having a different value for the rest of the field).

For example, suppose that the first several letters of a person's surname are less prone to mistake than the last several letters. Thus, two surnames with the same first few letters may likely be meant to have the same value. These pieces may be concatenated together to create a concise representation of the record called a “key”. Each record should contain a unique value for the record key. For example, when considering cleansing records of spare parts, the record key may be a serial number or part number. All records having the same key value have a reasonable chance of actually being meant to have the same value, and as a result represent the same entity. FIG. 15 illustrates this system, with the example of using the two characters of the last name value as the key.

Selection of what parts of what record fields make up the key is specialized and highly domain specific. Both of these properties point towards a larger, conceptual problem with this approach. This conventional observation implies that for every different type of application, a different method of key derivation has to be performed to get the most efficient use of this system. Also, this system is ineffective in dealing with typographical errors.

Another approach to that of the “key” clustering method is to limit the number of comparisons through the following method: create a “bucket” key for each record based on the field values; sort the entire database based on the bucket key; and compare records “near” each other in the sorted list using a similarity function. The definition of “near” is what limits the number of comparisons performed. Records are considered near each other if they are within “w” positions of the other records in the sorted list. The parameter “w” defines a window size. Conceptually this can be viewed as a window sliding along the record list. All of the records in the window are compared against each other using the similarity function. Like the bucket key described earlier, this bucket key consists of the concatenation of several ordered fields (or attributes) in the data record.

A weakness of this approach lies in the creating and sorting functions. If errors are present in the records, it is very likely that two records describing the same object may generate bucket keys that would be far apart in the sorted list. Thus, the records would never be in the same window and would never be considered promising candidates for comparison (i.e., they would not be detected as duplicates).

In FIG. 16, the location of the error in the record is the first letter of the last name. The bucket keys that were generated are therefore far apart in the sorted list. Although the records are highly similar (and very likely duplicate records), they will not be compared together as possible duplicates.

Creating a reliable bucket key in a first step depends on the existence of a field with high degree of standardization and low probability of typographical errors, (e.g., in customer records, Social Security Numbers, etc.). Unfortunately, this might not be present for all applications. Additionally, for very large databases (typically found in data warehouses) sorting the records (based on a bucket key) is not computationally feasible.

One conventional advanced approach involves the repeating of the creating and sorting steps for several different bucket keys, and then taking the “transitive closure” of the results for the comparing step from the repeated runs. “Transitive closure” means that if records R1 and R2 are candidates for merging based on window 1, and R2 and R3 are candidates for merging based on window 2, then consider R1 and R3 as candidates for merging. The tradeoff is that while multiple sorts and scans of the databases are needed (significantly increasing the computational complexity), this approach reduces the number of actual record comparisons needed in the comparing step since the “sliding window” may be made smaller.

### SUMMARY OF THE INVENTION

Using transform functions to fill cell-lists is an improved system for determining which records have “similar” values for a field than the key system. The key system is very domain specific, and dependent on a low amount of record noise in the data source. Transform functions that best handle the expected types of errors are more efficient for this application than the key system.

In accordance with the present invention, errors in the field no longer directly affect the quality of the “similarity” measurement. Transform functions create a “standardized” value for the record fields correcting common mistakes. Most transform functions replace information from the record field value most susceptible to the “noise” found in the data with a “more basic” representation. Examples of this would be phonetic transform functions replacing alphabetic values with their phonetic representations, sorting the field values alphabetically to handle transcription errors, and removing non-alphabetic characters.

Further, by allowing multiple transform functions to be applied to a single record field, a system in accordance with the present invention is robust against different types of errors in a field. Instead of treating every record field with one system (or one system trying to handle all error types), different systems may be applied separately. Having a finely tuned concept of “similarity” for field values makes the information useful for other applications.

A single system that removes too much information from a field may indicate large numbers of records share the same value for the field. Only transform functions appropriate to the type of information in the field may be applied to the field (to best handle the anticipated types of errors given the field type, information, source, etc.) if this information is available. A system in accordance with the present invention allows the integration of a mechanism for suggesting/selecting the set of appropriate transform functions to apply to a record field and the creation of a cell list structure.

Once created for a record collection, the cell-list structure may be stored efficiently for later use. Future records may be added to the cell-list structures very efficiently (real-time in most cases) without reprocessing the existing records in the collection. The marginal cost of adding a new record to the stored cell-list structure is no greater than if the record was part of the original collection. Removing a record from the cell-list structure is rudimentary as well. This means the system may further be used for iterative applications (where records are added/removed from the record collection over time).

### BRIEF DESCRIPTION OF THE DRAWINGS

The foregoing and other advantages and features of the present invention will become readily apparent from the following description as taken in conjunction with the accompanying drawings, wherein:

FIG. 1 is a schematic representation of one example part of a system for use with the present invention;

FIG. 2 is a schematic representation of another example part of a system for use with the present invention;

FIG. 3 is a schematic representation of still another example part of a system for use with the present invention;

FIG. 4 is a schematic representation of yet another example part of a system for use with the present invention;

FIG. 5 is a schematic representation of still another example part of a system for use with the present invention;

FIG. 6 is a schematic representation of yet another example part of a system for use with the present invention;

FIG. 7 is a schematic representation of the performance of a part of an example system in accordance with the present invention;

FIG. 8 is a schematic representation of a part of an example system in accordance with the present invention;

FIG. 9 is a schematic representation of another part of an example system in accordance with the present invention;

FIG. 10 is a schematic representation of still another part of an example system in accordance with the present invention;

FIG. 11 is a schematic representation of an input for an example system in accordance with the present invention;

FIG. 12 is a schematic representation of an operation of an example system in accordance with the present invention;

FIG. 13 is a schematic representation of another operation of an example system in accordance with the present invention;

FIG. 14 is a schematic representation of an output of an example system in accordance with the present invention;

FIG. 15 is a schematic representation of another system for identifying similarities in record fields; and

FIG. 16 is a schematic representation of still another system for identifying similarities in record fields.

### DETAILED DESCRIPTION OF AN EXAMPLE EMBODIMENT

A data cleansing system in accordance with the present invention (and supporting data structure) identifies groups of records that have “similar” values in different records of the same field. “Similar” means that all of the records in the field set would have the same value if the data were free of errors. The system is robust to “noise” present in real-world data (despite best attempts at standardization, normalization, and correction). The system involves the application of sets of transform functions to the fields in each of the records. Additionally, the system creates a data structure to store the similarity information of the associated records for each field.

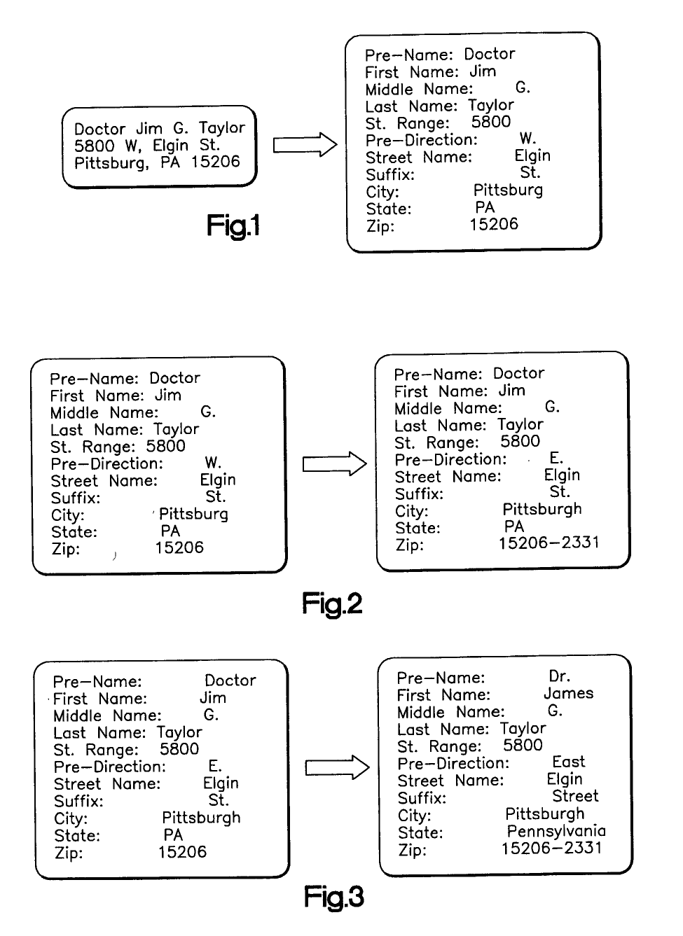

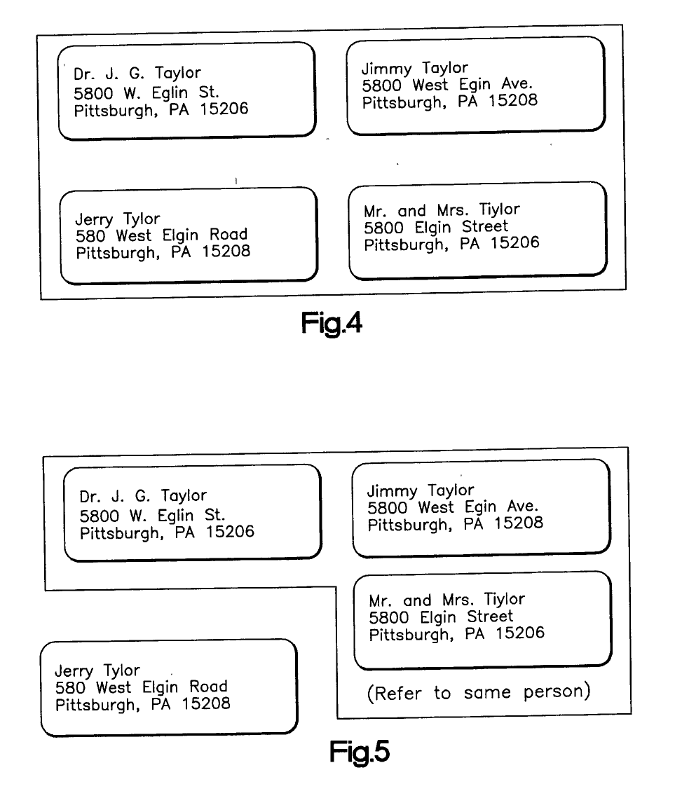

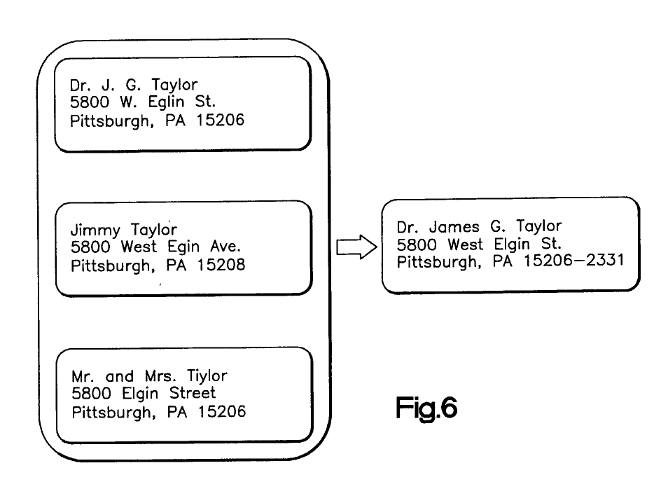

Typically, the data cleansing process can be broken down into the following steps: parsing (FIG. 1); validation/correction (FIG. 2); standardization (FIG. 3); clustering (FIG. 4); matching (FIG. 5); and merging (FIG. 6). Note that different approaches may consolidate these steps or add additional ones, but the process is essentially the same.

As viewed in FIG. 1, parsing intelligently breaks a text string into the correct data fields. Typically, the data is not found in an easily readable format and a significant amount of decoding needs to be done to determine which piece of text corresponds to what particular data field. Note that this step does not involve error correction.

Records may be formatted or free form. Formatted records have field values stored in a fixed order, and properly delineated. Free-form records have field values stored in any order, and it may be unclear where one field ends and another begins.

Once the string is parsed into the appropriate fields, the validation step, as viewed in FIG. 2, checks the field values for proper range and/or validity. Thus, a “truth” criteria must be provided as input to this step for each field.

The correction step updates the existing field value to reflect a specific truth value (i.e., correcting the spelling of “Pittsburgh” in FIG. 2). The correction step may use a recognized source of correct data such as a dictionary or a table of correct known values. For certain data, this step might not be feasible or appropriate and may be skipped.

As viewed in FIG. 3, the standardization step arranges the data in a consistent manner and/or a preferred format in order for it to be compared against data from other sources. The preferred format for the data must be provided as input to this step.

As viewed in FIG. 4, the clustering step creates groups of records likely to represent the same entity. Each group of records is termed a cluster. If constructed properly, each cluster contains all records in a database actually corresponding to a unique entity. A cluster may also contain some other records that correspond to other entities, but are similar enough to be considered. Preferably, the number of records in the cluster is very close to the number of records that actually correspond to the entity for which the cluster was built.

As viewed in FIG. 5, the matching step identifies the records in each cluster that actually refer to the same entity. The matching step searches the clusters with an application specific set of rules and utilizes a computational intensive search algorithm to match elements in a cluster to the unique entity. For example, the three indicated records in FIG. 5 likely correspond to the same person or entity, while the fourth record may be considered to have too many differences and likely represents a second person or entity.

As viewed in FIG. 6, the merging step utilizes information generated from the clustering and matching steps to combine multiple records into a unique (and preferably the most correct) view of each entity. The merging step may take data from fields of different records and “fuse” them into one, thereby providing the most accurate information available about the particular entity. The intelligent merging of several records into a single consolidated record ideally creates a new record that could replace the duplicate record cluster it was generated from without loss of any information.

In the clustering and matching steps, algorithms identify and remove duplicate or “garbage” records from the collection of records. Determining if two records are duplicates involves performing a similarity test that quantifies the similarity (i.e., a calculation of a similarity score) of two records. If the similarity score is greater than a certain threshold value, the records are considered duplicates.

Most data cleansing approaches limit the number of these “more intensive” comparisons to only the “most promising” record pairs, or pairs having the highest chance of producing a match. The reasoning is that “more intensive” comparisons of this type are generally very computationally expensive to perform. Many record pairs have no chance of being considered similar if compared (since the records may be very different in every field), thus the expensive comparison step was “wasted” if we simply compare every pair of records. The trade-off for not performing the “more intensive” inspection for every record pair is that some matches may be missed. Record pairs cannot have high enough similarity scores if the similarity score is never calculated.

For an example description of a system in accordance with the present invention, assume the record data is given, including format of the data and type of data expected to be seen in each record field. The format and type information describes the way the record data is conceptually modeled.

Each record contains information about a real-world entity. Each record can be divided into fields, each field describing an attribute of the entity. The format of each record includes information about the number of fields in the record and the order of the fields. The format also defines the type of data in each field (for example, whether the field contains a string, a number, date, etc.).

The clustering step produces a set of records “possibly” describing the same real-world entity. This set ideally includes all records actually describing that entity and records that “appear to” describe the same entity, but on closer examination may not. This step is similar to a human expert identifying similar records with a quick pass through the data (i.e., a quick pass step).

The matching step produces duplicate records, which are defined as records in the database actually describing the same real-world entity. This step is similar to a human expert identifying similar records with a careful pass through the data (i.e., a careful pass step).

The concepts of correctness using the terms “possibly describing” and “actually describing” refer to what a human expert would find if she/he examined the records. A system in accordance with the present invention is an improvement in both accuracy and efficiency over a human operator.

If constructed properly, each cluster contains all records in a database actually corresponding to the single real-world entity as well as additional records that would not be considered duplicates, as identified by a human expert. These clusters are further processed to the final duplicate record list during the matching step. The clustering step preferably makes few assumptions about the success of the parsing, verification/correction, and standardization steps, but performs better if these steps have been conducted accurately. In the clustering step, it is initially assumed that each record potentially refers to a distinct real-world entity, so a cluster is built for each record.

An example system in accordance with the present invention utilizes transform functions to convert data in a field to a format that will allow the data to be more efficiently and accurately compared to data in the same field in other records. Transform functions generate a “more basic” representation of a value. There are many possible transform functions, and the following descriptions of simple functions are examples only to help define the concept of transform functions.

A NONE (or REFLEXIVE) functiôn simply returns the value given to it. For example, NONE(James)=James. This function is not really useful, but is included as the simplest example of a transform function.

A SORT function removes non-alphanumerical characters, sorts all remaining characters in alphabetic or numerical order. For example, SORT (JAMMES)=aejmms, SORT(JAMES)=aejms, SORT (AJMES)=aejms. This function corrects, or overcomes, typical keyboarding errors like transposition of characters. Also, this function corrects situations where entire substrings in a field value may be ordered differently (for example, when dealing with hyphenated names: SORT(“Zeta-Jones”) returns a transformed value which is identical to SORT(“Jones-Zeta”).

A phonetic transform function gives the same code to letters or groups of letters that sound the same. The function is provided with basic information regarding character combinations that sound alike when spoken. Any of these “like sounding” character combinations in a field value are replaced by a common code, (e.g., “PH” sounds like “F”, so you give them both the same code of “F”). The result is a representation of “what the value sounds like.”

The goal is to find a criteria for identifying the “most promising” record pairs that is both lax enough to include all record pairs that actually match while including as few non-matching pairs as possible. As the criteria for “most-promising” record is relaxed, the number of non-matching pairs increases, and performance suffers. A strict criteria (i.e., only identical values deemed duplicate) improves performance, but may result in many matching records being skipped (i.e., multiple records for the same real-world entity).

The preferable criteria for identifying “most promising” record pair comparisons has to be flexible enough to handle the various sources of “noise” in the data that causes the syntactic differences in records describing the same entity (despite the best efforts at Standardization and Correction, or in cases where these steps are impossible). Noise represents the errors present in the data causing the syntactical differences between records describing the same objects (i.e., causes records to inappropriately have different values for the same field).

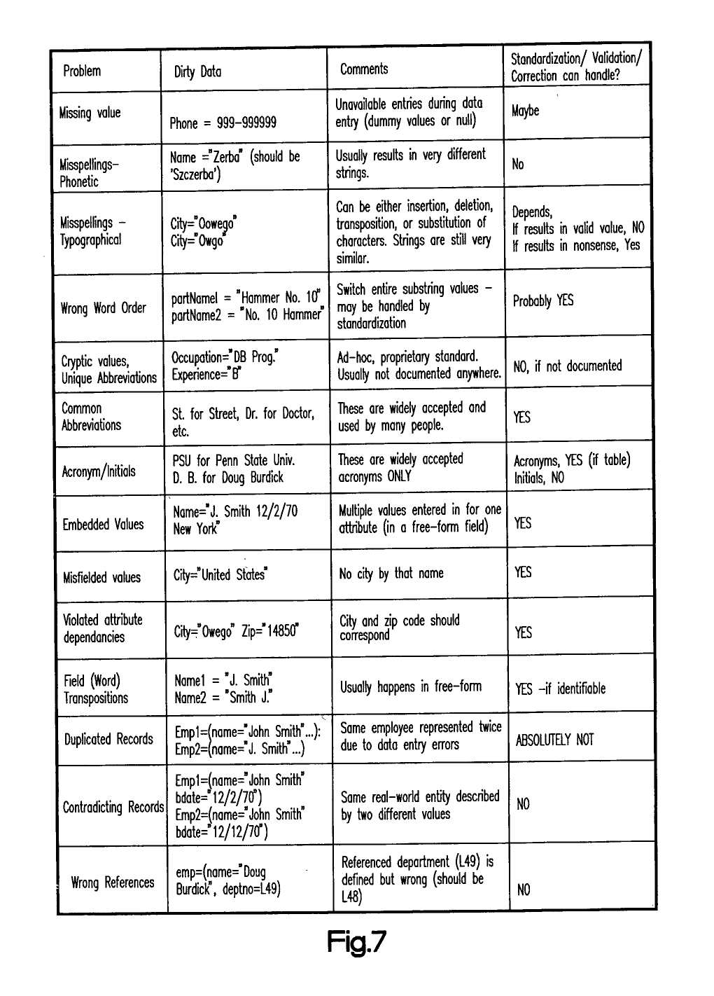

Examples of the types of errors that create noise typically found in practical applications are illustrated in FIG. 7. The standardization and validation/correction steps cannot overcome or detect some types of errors. This list is far from exhaustive and is meant for illustrative purposes only. The types of noise found in a particular record depend upon attributes such as the following: the source from which a record is created (keyboarded, scanned in, taken over phone, etc.); the type of value expected to be found in the field (numerical, alphabetical, etc.); and the type of information found in the field (addresses, names, part serial numbers, etc.).

Usually the criteria for “most promising” record pairs involves information about whether or not the record pair has the same (or highly similar) value for one or more record fields. The theory is that records describing the same real-world object would be very similar syntactically, possibly identical, if there was no noise in the record data.

To overcome noise, a system may accomplish the following two objectives: (1) identifying the field values that are “similar” (these values may be identical if there is no noise in the data; these values are close enough syntactically that it would be reasonable to assume that they may have been intended to be identical, but due the noise of the data, they are not); (2) for each field of the record, representing (and storing) information about the sets of records that were determined to have a similar value for the field.

A system 10 in accordance with the present invention addresses both objectives by identifying field values that have similar values through the application of one or more transform functions to the value of that particular field in each of the records. The system 10 also includes a structure to store information for each of the fields with “similar” values. This identification typically occurs in the clustering step.

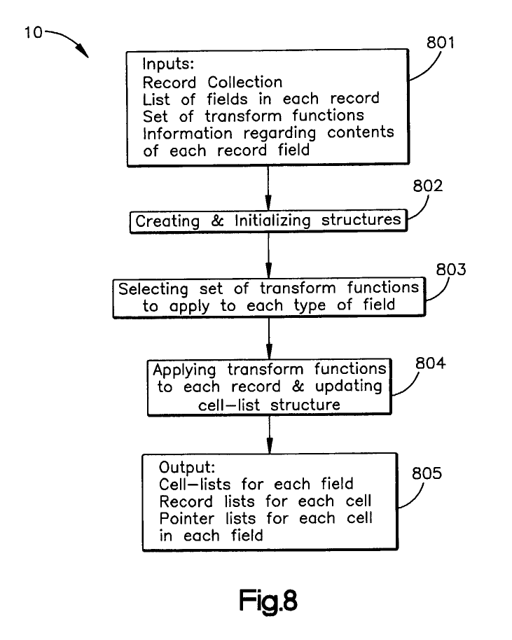

A high-level description of the system is illustrated in FIG. 8. The inputs 801 to the system 10 are the record collection, the list of fields in each record, the set of transform functions chosen for this particular record collection, and information regarding the contents of each record field (if available). The record collection is the set of records on which the system 10 is applied and may be a single set of records or a plurality of records lumped together. The list of fields in each record is assumed by the system 10 to be the same (or common) for all of the records.

Each transform function operates on a particular field value in each record. The set of transform functions is the set of all transform functions available for the system 10 to possibly use. Some transform functions may be applied to multiple fields, while others may not be used at all. Each field will have the most appropriate subset of these functions applied to it. Different functions may be applied to different fields. The information regarding the contents of each record field describes the types of information in the field. This information may be useful in determining which transform functions to apply to which type of record field. This information may or may not be available.

There are potentially thousands of transform functions available to the system, each handling a different type of error. Generally, only a small number of functions should be applied to a field. A transform function may be applied to several fields or to none.

Fields may also be grouped together that would likely to have switched values (e.g., first name and last name may be swapped, especially if both values are ambiguous—for example John James). The values in these grouped fields would be treated as coming from a single field. Thus, all of the transform function outputs for the field group would be compared against each other (See FIG. 14).

Determining what transforms to apply to each field and which fields should be grouped together can be done numerous ways. Examples include, but certainly are not limited to: analyzing the values in the record fields using a data-mining algorithm to find patterns in the data (for example, groups of fields that have many values in common); and based on the types of known errors found during the standardization and correction steps, select transform functions to handle similar errors that might have been missed. Further, based on errors parsing the record, fields likely to have values switched may be determined, and thus should be grouped together.

Another example includes using outside domain information. Depending on the type of data the record represents (e.g., customer address, inventory data, medical record) and how the record was entered into the database (e.g., keyboard, taken over phone, optical character recognition), certain types of mistakes are more likely than others to be present. Transform functions may be chosen to compensate appropriately.

The transform functions may be adaptively applied as well. For example, if there is a poor distribution of transformed values, additional transforms may be applied to the large set of offending records to refine the similarity information (i.e., decrease the number of records with the same value). Alternatively, a “hierarchy of similarity” may be constructed, as follows: three transform functions, T1, T2, T3, each have increasing specificity, meaning that each transform function separates the records into smaller groups. T3 separates records more narrowly than T2, and T2 separates records more narrowly than T1. Thus, the more selective transform function assigns the same output to a smaller range of values. Intuitively, this means that fewer records will have a value for the field that generates the same output value when the transform function is applied, so fewer records will be considered similar.

An example illustrating this concept, for illustrative purposes only, is described, as follows: Firstly, T1 is applied to Field 1 of the record collection. For any group of records larger than 20 that are assigned the same value by T1, T2 is applied to Field 1 of these “large” sized record groups. From this second group, if any group of records larger than 10 are assigned the same value by T2, then T3 is applied to Field 1 of these “medium” sized record groups.

Therefore, an iterative process may use feedback from multiple passes to refine the similarity information. Only as many functions as needed are applied to refine the similarity data, which increases efficiency of the application and prevents similarity information from being found that is too “granular” (splits records into too small groups).

Additionally, composite transform functions, or complex transform functions, may be applied that are built from a series of simpler transforms. For example, a transform function TRANS-COMPLEX that removes duplicate characters and sorts the characters alphabetically may be defined. TRANS-COMPLEX may be implemented by first performing a REMOVE-DUPLICATES function followed by a SORT function (described above). For example, TRANS-COMPLEX(JAMMES)=aejms and TRANS-COMPLEX(JAMMSE)=aejms.

A “fuzzy” notion of similarity may be introduced. A “fuzzy” similarity method uses a function to assign a similarity score between two field values. If the similarity score is above a certain threshold value, then the two values are considered good candidates to be the same (if the “noise” was not present).

The assigned similarity score may be based on several parameters. Examples of drivers for this similarity value are given below. These are only illustrate the form drivers may take and provide a flavor of what they could be.

A first driver may assign several transform functions to a field. A weight may be assigned to each transform function. The weight reflects how informative a similarity determination under this transform function actually is. If the transform function assigns the same output to many different values, then the transform function is very general and being considered “similar” by this transform function is less informative than a more selective function. A hierarchy of transform functions is thereby defined.

A second driver also may assign a similarity value between outputs from the same transform function. Slightly different output values might be considered similar. The similarity of two values may then be dynamically determined.

A third driver may dynamically assign threshold values through the learning system that selects a transform function. Threshold values may be lowered since similarity in some fields means less than similarity in other fields. This may depend on the selectivity of the fields (i.e., the number of different values the field takes relative to the record).

A fourth driver may incorporate correlations/patterns between field values across several fields into the assigning of similarity threshold values. For example, with street addresses, an obvious pattern could be derived by a data mining algorithm where city, state, and ZIP code are all related to each other, (i.e., given a state and a ZIP code, one can easily determine the corresponding city). If two records have identical states and ZIP values, a more lenient similarity determination for the two city values would be acceptable. Bayesian probabilities may also be utilized (i.e., if records A and B are very similar for field 1, field 2 is likely to be similar).

The functioning of the system 10 may be segregated into the following three steps: creating and initializing 802 the structures the system 10 will use; selecting 803 the appropriate set of transform functions to apply to each type of field (while many transform functions may be available, only a few are appropriate for the type of data for any one field; only these transform functions should be used; some functions may be used for multiple fields, while others may not be used at all; different functions can be applied to different fields; there are numerous acceptable ways to implement this step); and applying 804 the transform functions to each record by applying the appropriate transform functions to each field in each record and updating the resulting cell-list structure appropriately.

The output 805 of the system 10 is the completed cell-list structure for the record collection, representing information for each of the fields and sets of records having similar values for that field. The structure includes a cell-list for each field of each record. Each cell-list contains the name of the field for which the cell list was built and a list of cells. Each cell-list contains a value for the field of the cell-list containing it and a list of pointers to records containing that cell value in that field. All of the pointers generate a cell's value when one of the transform functions is applied to the field of each record.

The cell-list structure further includes a set of pointer lists, one for each field. Each pointer points to a cell. All of the pointers in a pointer list point to cells in the same cell-list. Each cell pointed to is in the cell-list.

An example of a completed cell-list structure is illustrated in FIG. 14. A sample record collection from which the cell-list structure was generated is illustrated in FIG. 11. The middle column of FIG. 14 illustrates a list of records. Record number 1 in FIG. 11 corresponds to record 1 of the middle column and so on. The cell-lists for the First Name and Last Name fields are the left and right columns of FIG. 14, respectively. Each cell is labeled with the value associated with it. The generation of these values is described below.

The arrows in FIG. 14 represent pointers between cells. Cells point to appropriate records and records point to appropriate cells (each single bi-directional arrow in FIG. 14 may also be represented by two arrows each going in a single direction).

As described above, at the highest level, the system 10 may be segregated into the five steps illustrated in FIG. 8. In step 801, the system 10 provides the inputs, as follows: a record collection; a list of fields in each record; a set of transform functions; and information about field contents, if available. Following step 801, the system 10 proceeds to step 802. In step 802, the system 10 creates cell-list structures for each of the fields, and initializes them to empty. For each record in the record collection, a record is created. The pointer list for each of the records is initialized to empty. Following step 802, the system 10 proceeds to step 803. In step 803, the system 10 selects appropriate transform functions to apply to each field in each record. There are numerous ways to implement a system for selecting which transform functions to apply to each field from any given set of transform functions. While there may be a multitude of transform functions, only a handful may be appropriate to apply to any particular field. Generally, choosing functions to apply to a field involves some domain-dependent knowledge. Not all of the transform functions are applied to each field, only ones that make sense given the expected types of errors in the data.

Alternatively, the same transform function may be applied to multiple fields, if appropriate. For example, data entered by keyboard likely contains typographical errors, while data records received from telephone calls would more likely contain phonetic spelling errors. Suitable transform functions result in standardized values tailored to these error sources.

Transform functions operate on values in particular fields where fields are defined in the record format. The transform functions are chosen to help overcome clerical errors in field values that might not (or cannot) be caught during the standardization step, such as those illustrated in FIG. 7.

Errors that result in valid, but incorrect field values typically cannot be determined. For example, in the example record set in FIG. 11, record 5 has the value “Jammes” for the FirstName field. The value “Jammes” might be a valid name, but not the intended value for this record (the typist inserted an extra character into “James”—a common mistake). The intention of the typist cannot be checked, only whether the result is valid. Almost all of the errors that standardization/validity/correction cannot determine are of this type. However, these errors result in values that are usually very similar syntactically or phonetically to the intended value (for example, “Jammes” for “James”).

Following step 803, the system 10 proceeds to step 804. In step 804, the system 10 updates the cell list structures through application of the transform functions. Following step 804, the system 10 proceeds to step 805. In step 805, the system 10 provides output, as follows: cell lists for each field; record lists for each cell; pointer lists for each cell in each field.

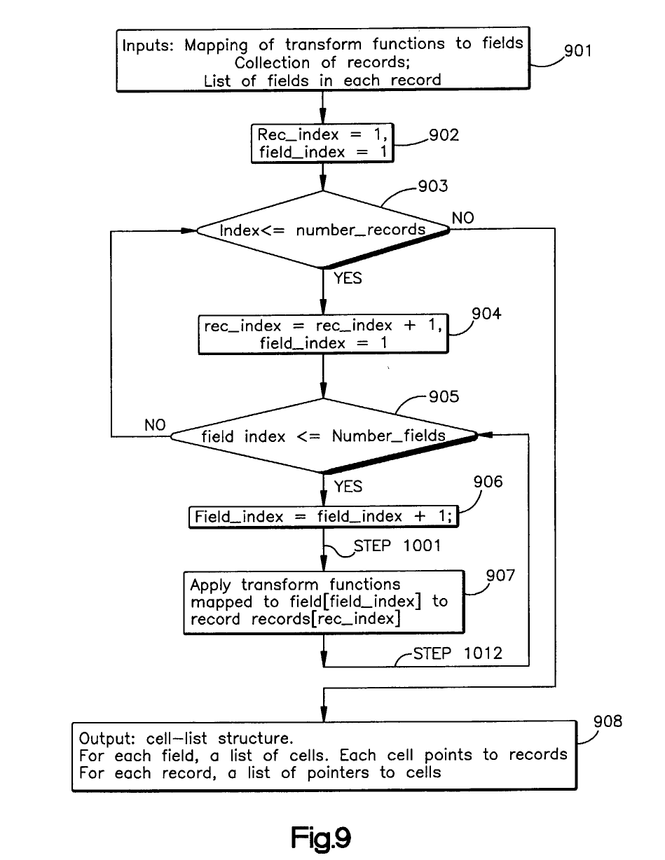

In one example method of updating the cell-list structure (step 804 of FIG. 8), the cell-lists are filled, as illustrated in FIG. 9. In step 901, the inputs are provided, as follows: the mapping of transform functions to fields; the collection of records; and the list of the fields in each record. Following step 901, the method proceeds to step 902. In step 902, the method creates and initializes the variables rec_index and field_index to 1. These variables track the progress of the method during execution, and more specifically, what field of what record is currently being processed. Following step 902, the method proceeds to step 903.

In step 903, the method compares rec_index to the total number of records in the record collection (i.e., the variable number_records). If the rec_index is less than number_records, records remain to be processed and the method proceeds to step 904. If rec_index equals number_records, the method proceeds to step 908 and the method terminates with its output. The output is a cell list structure consisting of a list of cells for each field with each cell pointing to a record and a list of pointers to the cells for each record (FIG. 14).

In step 904, the method increments rec_index and sets field_index equal to 1 to signify the processing of the first field in the next record in the record collection. Following step 904, the method proceeds to step 905. In step 905, the method compares the field_index to the total number of fields in each record (i.e., the variable number_fields). If the field_index is less than number_fields, fields in the record remain to be processed and the method proceeds to step 906. If the field_index equals number_fields, the method returns to step 903 to process the next record.

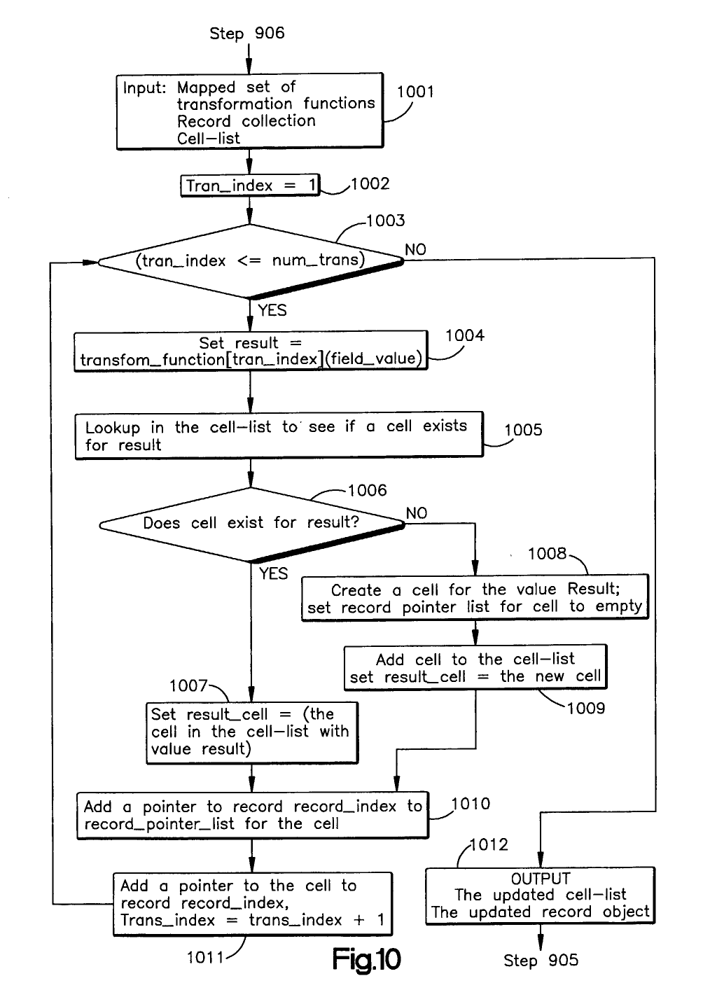

In step 906, the method increments field_index to signify the processing of the next field in the record. Following step 906, the method proceeds to step 907. In step 907, the method applies the transform function(s) mapped to this field (FIG. 10 and described below). Following step 907, the method returns to step 905.

FIG. 10 illustrates one example method of applying transform function(s) to a particular field of a particular record to be updated by the method of FIG. 9 (step 907 of FIG. 9). In step 1001, the inputs are provided, as follows: transform function(s) mapped to this field; a cell list for this field; a record for this record_index; and a field value for this field. Following step 1001, the method proceeds to step 1002. In step 1002, the method creates and initializes the variable tran_index to 1. This variable tracks what transform functions have been applied by the method thus far. Following step 1002, the method proceeds to step 1003. In step 1003, the method compares tran_index to the total number of transform functions associated with this field (i.e., the variable num_trans). If tran_index is less than num_trans, transform functions remain to be applied to this field and the method proceeds to step 1004. If tran_index equals num_trans, the method proceeds to step 1012 and the method terminates with its output. The output is the updated cell list and the record modified by the appropriate transform function(s).

In step 1004, the method applies a transform function to the field value and sets the output to the variable Result. Following step 1004, the method proceeds to step 1005. In step 1005, the method examines the cell list to determine if a cell exists with the value Result. Following step 1005, the method proceeds to step 1006. In step 1006, the method determines whether to create a new cell for the value of Result. If a cell exists for Result, the method proceeds to step 1007. If a cell does not exist for Result, the method proceeds to step 1008.

In step 1007, the method sets the variable result_cell to point to the cell from the cell list that has the value Result. Following step 1007, the method proceeds to step 1010.

In step 1008, the method creates a cell with the value Result and sets the record_pointer list for the cell to empty. Following step 1008, the method proceeds to step 1009. In step 1009, the method adds the created cell for Result to the cell list and sets result_cell to point to the created cell. Following step 1009, the method proceeds to step 1010.

In step 1010, the method adds result_cell to the record_pointer list for the newly created or existing cell. Following step 1010, the method proceeds to step 1011. In step 1011, the method increments tran_index to signify that the application of the transform function tran_index is complete. Following step 1011, the method returns to step 1003.

FIGS. 11-13 illustrate a simple example of the operation of the system 10. This is a simple case and meant to be only an example of how the system 10 works with one possible implementation. As viewed in FIG. 11, the database has 8 records and each record has 2 fields: FirstName and LastName. The following two transform functions, as described above, are given. The NONE function simply returns the value given to it. The SORT function removes non-alphanumerical characters, sorts all remaining characters in alphabetic or numerical order, and removes duplicates.

The system 10 creates a list of 8 records (step 801 of FIG. 8), one for each record in the database of FIG. 11. The system 10 creates an empty cell-list for the FirstName field and LastName field (step 802 of FIG. 8). The system 10 decides to apply the NONE transform to the FirstName field and both the NONE and SORT functions to the LastName field (step 803 of FIG. 8). This is just one example of the numerous ways to implement the step of mapping transforms to fields.

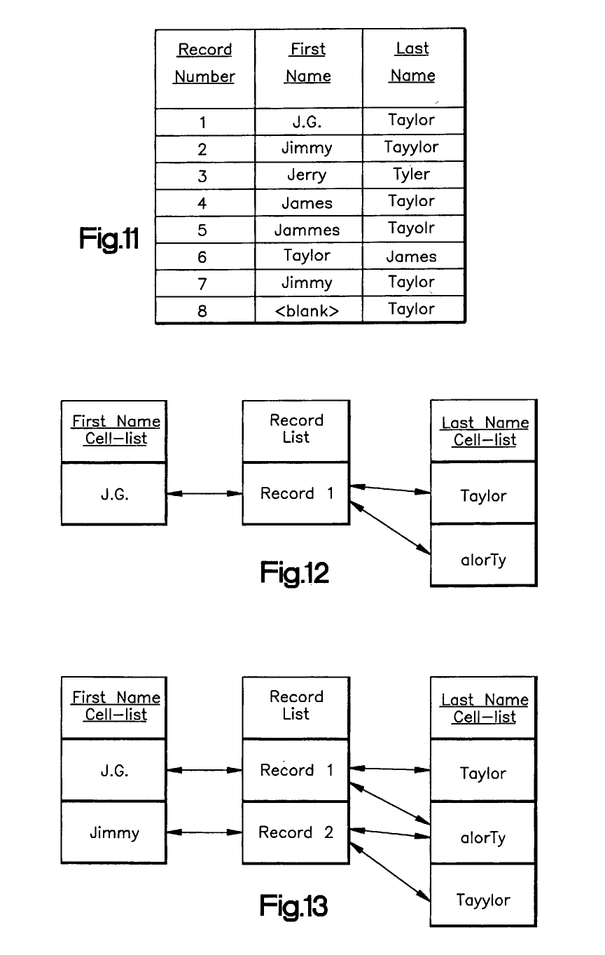

The system 10 constructs the cell-list structure (step 804 of FIG. 8). FIG. 12 illustrates the state of the structure after record 1 has been processed. Record 1 is processed as follows. For the FirstName field, record 1 has “J.G.”. The transform function NONE is applied, resulting in value “J.G.” Since there is no cell in the FirstName cell-list for this value, a cell for “J.G.” is added to the FirstName cell-list. Record 1 points to this new cell and this new cell points to record 1.

For the LastName field, record 1 has “Taylor”. The transform function NONE is applied, resulting in the value “Taylor”. Since there is no cell in the LastName cell-list for this value, a cell for “Taylor” is added to the LastName cell-list. Record 1 points to this new cell and this new cell points to record 1. Next, the transform function SORT is applied to “Taylor”, resulting in “alorTy”. Since there is no cell in the LastName cell-list for this value, a cell for “alorTy” is added to the LastName cell-list. Record 1 points to this new cell and this new cell points to record 1.

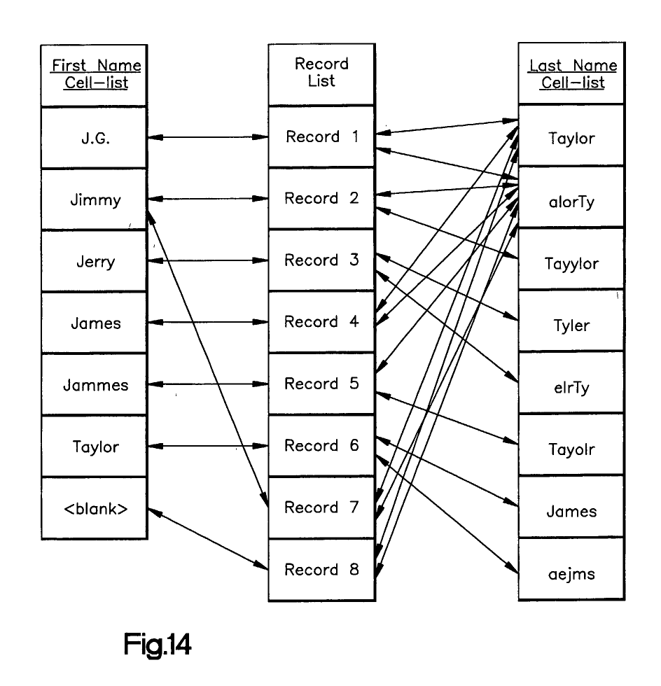

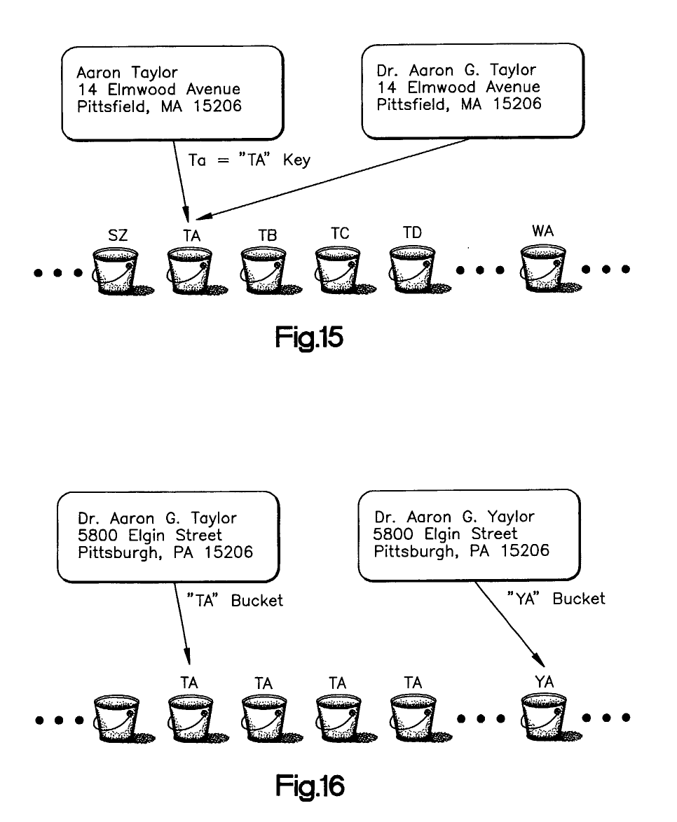

FIG. 13 illustrates the status of the cell-list structure after record 2 has been processed. This is only an example of how the system 10 with this example implementation may operate. Record 2 is processed as follows. For the FirstName field, record 2 has “Jimmy”. The transform function NONE is applied, resulting in value “Jimmy.” Since there is no cell in the FirstName cell-list for this value, a cell for “Jimmy” is added to the FirstName cell-list. Record 2 points to this new cell and this new cell points to record 2. For the LastName field, record 2 has “Tayylor”. The transform NONE is applied, resulting in the value “Tayylor”. Since there is no cell in the LastName cell-list for this value, a cell for “Tayylor” is added to the LastName cell-list. Record 2 points to this new cell and this new cell points to record 2. Next, the transform function SORT is applied to “Tayylor”, resulting in “alorTy”. Since there is a cell already for “alorTy” in the LastName cell-list, a pointer from the “alorTy” cell of the LastName cell-list to record 2 is added and a pointer from record 2 to the “alorTy” cell.

The continuing operation of the system 10 in this manner generates the cell-list structure (step 805 of FIG. 8) shown in FIG. 14 (i.e., after the entire record collection of 8 record objects is processed). The arrows in the figure represent pointers between records. Cells point to appropriate records and records point to appropriate cells (each single bi-directional arrow in FIG. 14 could also be represented by two arrows each going in a single direction).

The middle column of FIG. 14 represents the list of records. The first and third columns of FIG. 14 represent the cell-lists of the outputs of the transform functions for the FirstName and LastName fields, respectively. Each cell in the cell-list is labeled with the output value associated with the cell. The cells in FIG. 14 are ordered from the top. For each different value in the cells in the FirstName field, an output value is associated with it in a FirstName cell-list. For each different value in the cells in the LastName field, an output value is associated with it in a LastName cell-list.

Once the cell list structure is in the form partially illustrated in FIG. 14, clustering, matching, and/or merging may be conducted to eliminate duplicate records and produce a cleansed final product (i.e., a complete record collection). The only reason that untransformed values still appear in FIG. 14 is that the simple NONE transform function was utilized for example purposes.

From the above description of the invention, those skilled in the art will perceive improvements, changes and modifications. Such improvements, changes and modifications within the skill of the art are intended to be covered by the appended claims.

Having described the invention, the following is claimed:

1. A system for identifying similarities in data, said system comprising:
a collection of records, each said record in said collection representing an entity, each said record in said collection having a list of fields and data contained in each said field;
a plurality of transform functions for operating upon the data in each said field in each said record, said plurality of transform functions generating a set of output values for facilitating comparison of said records and determining whether any of said records represent the same entity;
a cell list structure generated from said output values,
said cell list structure having a list of cells for each field and a list of pointers to each said cell of said list of cells for each output value generated by said plurality of transform functions.

2. The system as set forth in claim 1 wherein said collection of records is formed by parsing data for each said record into fields.

3. The system as set forth in claim 1 wherein said plurality of transform functions operate upon the data during a clustering step.

4. A method for cleansing electronic data, said method comprising the steps of:
inputting a collection of records, each record in the collection representing an entity having a list of fields and data contained in each of the fields;
selecting a plurality of transform functions for operating upon the data in the list of fields;
generating a set of output values with the plurality of transform functions;
generating a cell list structure from the output values; and
outputting the cell list structure, the cell list structure having a list of cells for each field and a list of pointers to each cell of the cell list for each unique output value generated by the plurality of transform functions.

5. The method as set forth in claim 4 further includes the step of parsing the data for each said record into fields.

6. The method as set forth in claim 4 further includes the step of correcting errors in the data by reference to a recognized source of correct data.

7. The method as set forth in claim 4 further including the step of eliminating records representing the same entity.
